(19) United States
(12) Patent Application Publication
(10) Pub. No.: US 2014/0317186 A1
(43) Pub. Date: Oct. 23, 2014

(54) Organization of Captured Media Items

(71) Applicant: NOKIA CORPORATION, Espoo (FI)

(72) Inventors: Sami Niemi, Skanor (SE); David Fredh, Malmo (SE); Martin Henriz, Lund (SE); Marcus Hast, Malmo (SE)

(73) Assignee: NOKIA CORPORATION, Espoo (FI)

(21) Appl. No.: 14/128,128

(22) PCT Filed: Jun. 20, 2012
(86) PCT No.: PCT/SE2012/050689

§ 371 Date: Mar. 18, 2014

Related U.S. Application Data
(60) Provisional application No. 61/502,525, filed on Jun. 29, 2011.

(30) Foreign Application Priority Data
Jun. 29, 2011 (SE) 1150600-3

(51) Int. Cl. H04L 29/06

(52) U.S. Cl. CPC H04L 65/403
USPC 709/204

(57) ABSTRACT

The present invention relates to mechanisms for sharing media items connected to an event between user accounts. An event for media items is created where the event is associated with a context. The created event is associated with a user account. The created event is shared with at least one further user account. The user account and the at least one further user account are associated with a specified subset of user accounts from at least one group of user accounts. Captured media items are connected to the created event. The captured media items are associated with the user account or the at least one further user account. The user account and the at least one further user are provided access to the connected media items. The connected media items are thereby enabled to be shared amongst the user account and the at least one further user account.

### TECHNICAL FIELD OF THE INVENTION

The present invention relates to the field of communications systems, and more particularly to sharing media items connected to an event between user accounts in a communications system.

### BACKGROUND OF THE INVENTION

Over the last few years communications devices, such as mobile phones, have evolved from being just communications devices to being handheld multimedia devices. In addition, more and more devices are being provided with communications interfaces. Thus, the number of devices being able to communicate information between each other is constantly increasing.

The number of services and applications being based on communications between such devices is also increases. A few examples include, but are not limited to, social medias based on digital networks, instant message sharing, sharing and displaying of information, and the like.

Thus, as the number of communications devices increases so too does the need to communicate data between the communications devices. It may therefore be desired that the communications devices should be arranged to share content with each other in an intuitive and instant way.

There currently exists many ways to associate data files, such as captured media items, with auxiliary data, such as metadata or tags. One example is image files having Exif data, for example GPS data and/or date/time for capture of the images. By using GPS data the location of where an image was captured may be indicated on a geographical map. A user is thereby enabled to capture a media item, such as an image of a scene, and later automatically determine the location of the captured media item on a map by mapping the GPS data of the image to the map. The map may then be shared with other users, for example by publishing the map on the Internet.

### SUMMARY OF THE INVENTION

In view of the above it may still be difficult to put the captured media items in a larger context. Particularly, it may still be difficult to efficiently organize, synchronize and/or share large sets of captured media items, such as image files, audio files and video files. An object is therefore to simplify organization, synchronization and/or sharing of large sets of captured media items.

A further object is to provide a mechanism for data mining which can be used to provide intelligent conclusions regarding the data, so as to put the data content in a context.

According to a first aspect there is provided a method for sharing captured media items connected to an event between user accounts, comprising creating an event for media items, the event being associated with a context; associating the created event with a user account; sharing the created event with at least one further user account, the user account and the at least one further user account being associated with a specified subset of user accounts from at least one group of user accounts; connecting captured media items to the created event, the captured media items being associated with the user account or the at least one further user account; and providing the user account and the at least one further user account access to the connected media items, thereby enabling the connected media items to be shared amongst the user account and the at least one further user account.

By using the proposed inventive concepts a user account may be provided with information regarding other user accounts and/or communications devices which may be associated with the captured media items. Thereby the proposed inventive concepts enable handling of large amounts of data in a structured way such that intelligent conclusions can be drawn therefrom. By associating the captured media items to a created event the captured media items are put in a larger context, or in other words: content is put in a context. This advantageously enables improved organization, synchronization and/or sharing of large sets of captured media items.

According to a second aspect there is provided a communications device for sharing captured media items connected to an event between user accounts, comprising a communications unit arranged to receive instructions to create an event for media items, the event being associated with a context; a processing unit arranged to create the event; the processing unit being further arranged to associate the created event with a user account; the communications unit being further arranged to communicate the created event to a further communications device, thereby enabling the created event to be shared with at least one further user account, the user account and the at least one further user account being associated with a specified subset of user accounts from at least one group of user accounts; the processing unit being further arranged to connect captured media items to the created event, the captured media items being associated with the user account or the at least one further user account; and the processing unit being further arranged to provide the user account and the at least one further user account access to the connected media items, thereby enabling the connected media items to be shared amongst the user account and the at least one further user account.

According to a third aspect there is provided a communications device for sharing captured media items connected to an event between user accounts, comprising a communications unit arranged to receive a created event for media items, the event being associated with a context; a processing unit arranged to associate the created event with a user account; the processing unit being further arranged to enable the created event to be shared with at least one further user account, the user account and the at least one further user account being associated with a specified subset of user accounts from at least one group of user accounts; the processing unit being further arranged to connect captured media items to the created event, the captured media items being associated with the user account or the at least one further user account; the processing unit being further arranged to provide the user account and the at least one further user account access to the connected media items, thereby enabling the connected media items to be shared amongst the user account and the at least one further user account.

According to an fourth aspect there is provided a computer program product comprising software instructions that when downloaded to a computer is configured to perform a method according to any one of the methods as disclosed above. The computer program may be stored on a non-volatile storage medium.

The second, third, and fourth aspects may generally have the same features and advantages as the first aspect. Other objectives, features and advantages of the present invention will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

Embodiments of the present invention will now be described in more detail by way of non-limiting examples, reference being made to the enclosed drawings, in which:

FIG. 1 is a schematic illustration of a communications device according to embodiments;

FIG. 2 is a schematic illustration of a communications system according to embodiments;

FIG. 3 is a schematic illustration of created events and their associations with user accounts;

FIGS. 4a-f are schematic illustrations of created events;

FIG. 5 is a schematic illustration of created events along a time line;

FIG. 6 is a schematic illustration of groups; and

FIG. 7 is a flowchart of a method according to embodiments.

### DETAILED DESCRIPTION OF PREFERRED EMBODIMENTS

The present invention will now be described more fully hereinafter with reference to the accompanying drawings, in which certain embodiments are shown. Like numbers refer to like elements throughout. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art.

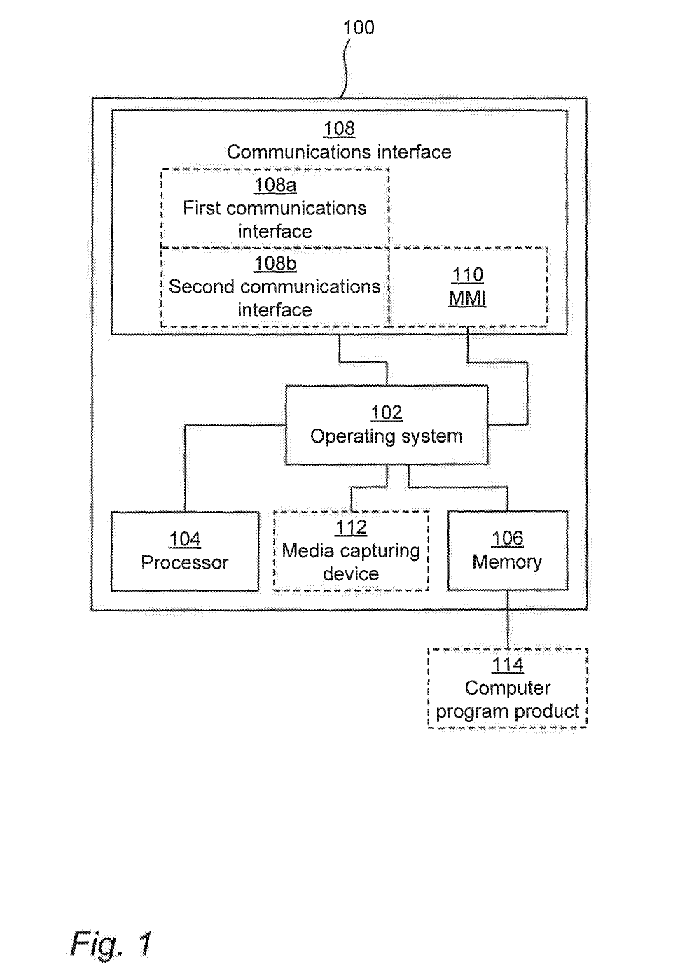

FIG. 1 is a schematic illustration of a communications device 100 according to an embodiment. The communications device 100 is preferably a mobile phone, a computer (such as a stationary computer, a laptop computer, or tablet computer, or a personal digital assistant (PDA). The communications device 100 generally comprises circuitry arranged to perform a number of operations and will now be described in terms of functional blocks. In general, the functional blocks may be implemented in various ways, such as by programming one or more field programmable gate arrays (FPGAs), applications specified integrated circuits (ASICs), or the like.

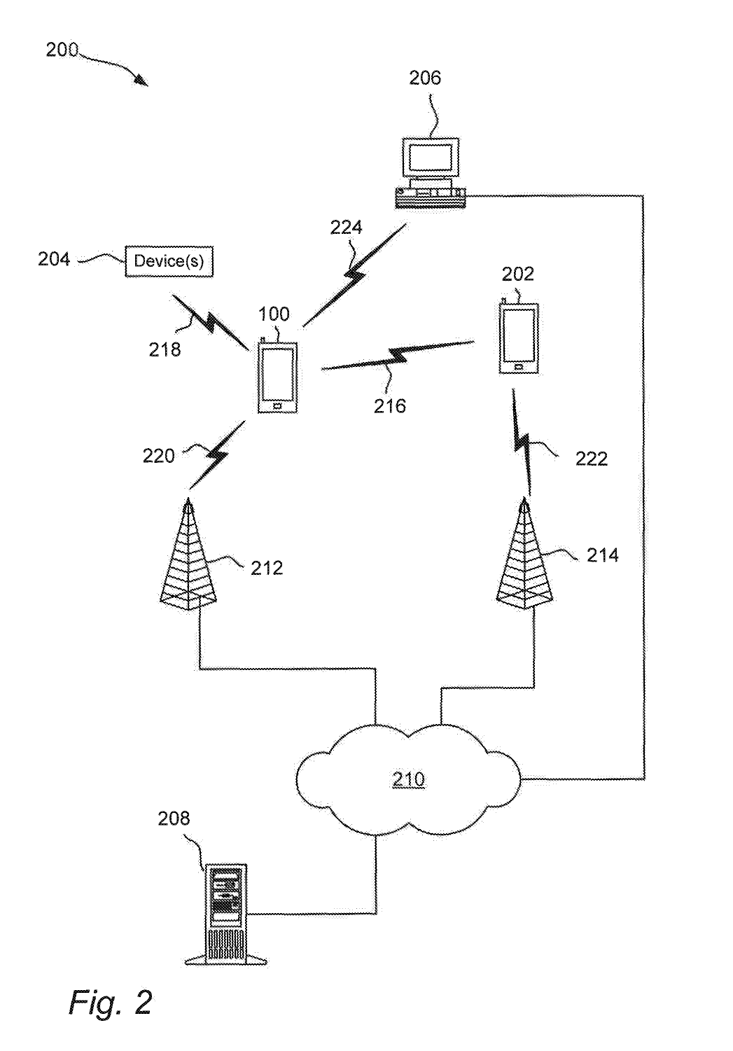

The communications device 100 is run under supervision of an operating system 102 and comprises a processor functional block 104, which may be embodied as a central processing unit and/or a dedicated image processing unit, such as a JPEG hardware accelerator. The processor functional block 104 may also refer to a graphics processing unit (GPU), capable of calculations, such as pixel/fragment shaders in OpenGL/OpenCL. The image processing unit may be implemented as a computer program product comprising one or more software components, or as a dedicated hardware unit for image processing. The software components may comprise software instructions that when downloaded to a computer are configured to perform the instructions associated with the processing unit. The communications device 100 further comprises a memory functional block 106, which may be embodied as a memory or a non-volatile computer-readable storage medium, such as a random access memory (RAM), a read-only memory (ROM), a universal series bus (USB) product, such as a memory stick, or the like. Particularly, the memory functional block 106 may hold a computer program product 114 comprising software instructions that, when downloaded to a computer, such as the communications device 100, and run on the processor 104 are configured to perform the subject matter disclosed herein. Alternatively, the software instructions may be separately distributable to be distributed in a network, see FIG. 2.

The communications device 100 further comprises a communications unit functional block 108, which may be embodied as a receiver and a transmitter and/or a transceiver, inter alia configured to receive input from, and deliver output to, a man-machine interface (MMI) functional block 110, another communications device, computer, or the like. Particularly, the communications unit functional block 108 may comprise a first communications interface 108a and a second communications interface 108b. The man-machine interface (MMI) functional block 110 may define a user interface. The user interface may be an integral part of the second communications interface 108b.

The communications device 100 may further comprise a media capturing unit 112, which may be embodied as a digital camera, video camera or audio recorder, or the like. Alternatively the communications device 100 may be operatively coupled to an external media capturing unit or device (not shown) via the communications unit functional block 108. The communications device 100 may thereby have access to sets of media items from which one or more media items may be selected. For example, media items in the form of digital images may originate from still images or from a video sequence, such as a video file, or from a video surveillance camera. The external media capturing unit may be coupled to the communications device 100 through an external network interface which may be either wired, or wireless, such as a 3G modem, or a WLAN.

FIG. 2 illustrates an example of a communications system 200 in which embodiments of the disclosed subject matter may be applied. In the communications system 200 of FIG. 2, various data services such as media items sharing, event sharing, cellular voice calls, www/wap browsing, cellular video calls, data calls, facsimile transmissions, music transmissions, still image transmissions, video transmissions, electronic message transmissions, electronic positioning information, and electronic commerce may be performed between the communications device 100 and other devices, such as one or more further communications devices 202, 204, 206, or a server 208. For different embodiments of the communications devices 100, 202, 204, 206 and in different situations relating to the operating conditions of the communications system 200, different ones of the data services referred to above may or may not be available; the disclosed subject matter is not limited to any particular set of services in this respect.

The communications devices 100, 202, 204, 206 may be arranged to be wirelessly operatively connected to a network 210 through radio frequency links 220, 222 via base stations 212, 214. The base stations 212, 214 are operatively connected to the network 210. The network 210 may be in compliance with any commercially available network standard, such as GSM, UMTS, D-AMPS, CDMA2000, FOMA, TD-SCDMA, IPv4, IPv6 and the like. The communications devices 100, 202, 204, 206 may also be arranged to be operatively connected to a network 210 by electric wires or optical fiber cables.

The network 210 may be an integrated part of the Internet and may host a computer based cloud service. A server 208, which may be an Internet server, generally has a data storage and is operatively connected to the network 210. The server 208 may host a www/wap server capable of serving www/wap content to the communications devices 100, 202. The server 208 may also be a server for a general data service.

The communications device 100 may also be capable of communicating locally via a local link 218 to one or more local communications device(s) 204. The local link can be any type of link with a limited range, such as Bluetooth, a Universal Serial Bus (USB) link, a Wireless Universal Serial Bus (WUSB) link, an IEEE 802.11 wireless local area network link, an RS-232 serial link, and communications aided by the infrared data association (IrDA) standard, etc. The communications device 100 may similarly be capable of communicating locally via a local links 216, 224 to the one or more further communications devices 202, 206.

A mechanism for data mining which can be used to provide content in a context is proposed. A data miner functionality is arranged to draw intelligent conclusions based on stored database information comprising meta data and received meta data. The stored meta data may include a media items database, (geographical) map data and/or already created associations between communications devices and users (so called “events”). The received meta data may relate to captured media items having meta data associated therewith, as well as to information on the Internet. The mechanism may include object recognition and means for analyzing received meta data and captured media items and for associating the same with stored database information such that conclusions regarding the media items can be drawn.

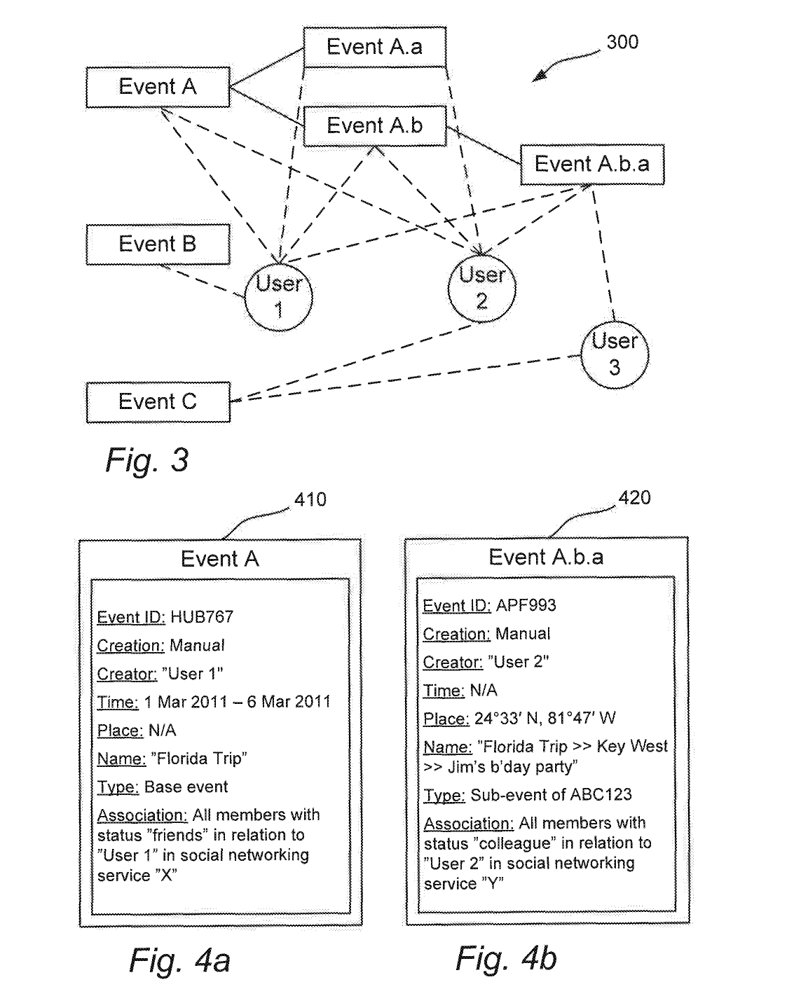

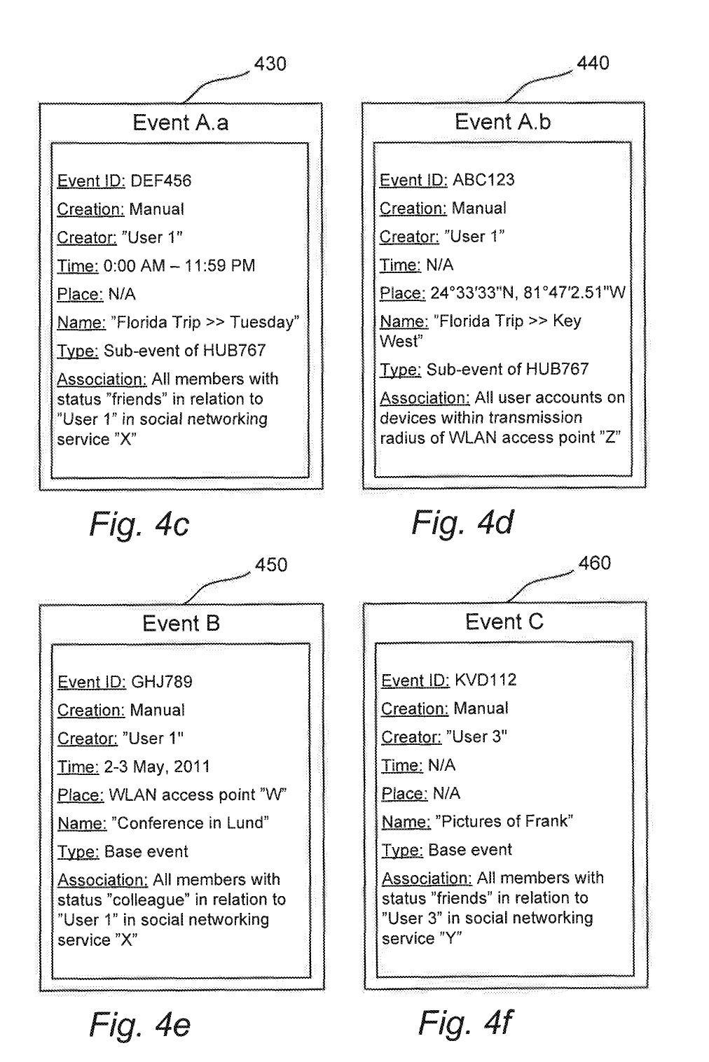

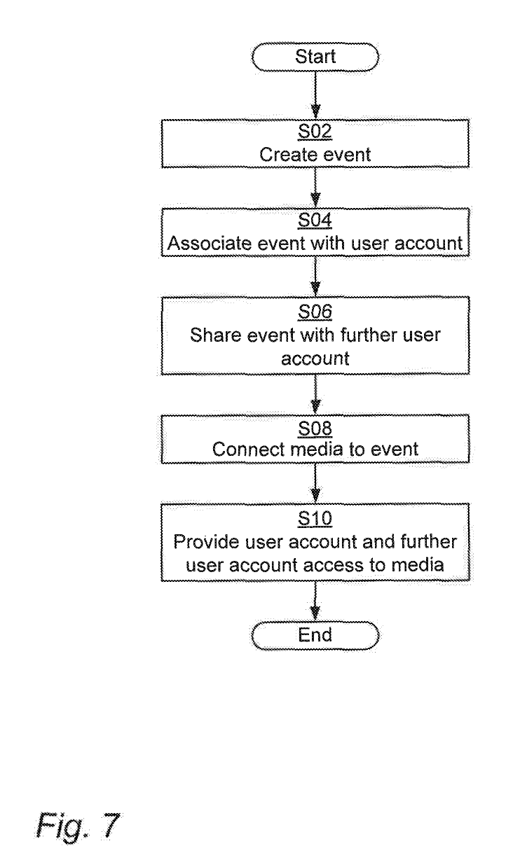

The mechanisms, embodied by methods and means (provided in one or more of the entities disclosed above with references to FIGS. 1 and 2), for sharing media items connected to an event between user accounts will be primarily described with references to FIGS. 1 and 2, as well as the flowchart of FIG. 7. Additional illustrative exemplary embodiments are provided in FIGS. 3, 4a-f, 5 and 6.

The mechanisms may be provided as one or more software components that when stored on a device forms an executable user account application. A user may interact with the user account application by providing user commands, such as user input, to the user interface 110 of the communications device 100, 202, 206 running (and hence executing) the user account application. In order for the acts and/or steps disclosed herein to be performed it may thus be required that the communications device 100, 202, 206 carrying out the acts and/or steps runs and executes a user account application comprising these software components.

In a step S02 an event for media items is created. The event may be actively created upon reception of user input. The creation may be performed in the processing unit 104 of the communications device 100. A user may, for example, provide a sequence of commands through the user interface 110 which causes the event to be created. The commands may involve entering a user account application provided in the communications device 100, 202, 206 and providing the created event with properties, such as a name. Text comments provided by users on a social networking service associated with the user account may be used in order for the communications device 100, 202, 206 to automatically suggest to the user a name of the event that is to be created. The user account application may thus obtain user comments from a specified subset of user accounts and suggesting an identity of the event to be created based on the user comments. Alternatively the event may be automatically created based on, for example, network identification data. The communications unit 108 may thus be arranged to receive an already created event for the media items. The identification data may be based on identification data from (an access point of) at least one WLAN, GPS coordinates, and/or Bluetooth identification data. Information regarding the identification data may be presented on the user interface 110 of the communications device 100, 202, 206 when being within the transmission radius of (or operatively connected to) an access point to the WLAN, GPS device or device transmitting Bluetooth identification data. Once created, data relating to the event may be transmitted from the communications device, 202, 206 to the server 208 via the network 210 in order to store the created event in the server 208.

The event is associated with a context. According to an embodiment the context is specified by user input. In this case the context may correspond to the name of the event. The context may also pertain to a limited time interval and/or a specified geographical location. The context may thereby limit the event in time and/or space. There are different ways of acquiring data in order to determine the geographical location. As a first example, the geographical location may be further defined by identification of an access point of a wireless local area network (WLAN). As a second example the geographical location may be further defined by a set of global positioning system (GPS) coordinates.

In a step S04 the created event is associated with a user account. The association may be performed in the processing unit 104. A (virtual) link is thus provided between the created event and the user account so as to initially tie the created event to a particular user account. The particular user account may thereby be associated with authorization relating inter alia to changing properties of the created event or making other amendments to the created event. Further aspects relating to authorization will be disclosed below in connection with one of the user account and the at least one further user account acting as a moderator of the created event. The created event may be associated with captured media items from both the user account mentioned in steps S02 and S04 and at least one further user account as will be mentioned below in step S06.

In a step S06 the created event is shared with at least one further user account. The sharing may be performed in the processing unit 104 which may instruct the communications unit 108 of the communications device 100, 202, 206 to transmit an information sequence to the server 208 that the created event is to be shared. The application run on the communications device 100, 202, 206 or the server 208 may explicitly add user accounts with which the event is to be shared. For example, the communications device 100, 202, 206 may itself be arranged to receive user input relating to at least one additional user account with which the created event is to be shared. The user account application run on the communications device 100, 202, 206 may then directly add the at least one additional user account to the created event as a result thereof, or indirectly add the at least one additional user account to the created event by transmitting an information sequence to the server 208 to do so. Yet alternatively the sharing of the created event to the at least one further user account may be performed directly in the server 208, i.e. without the communications device 100, 202, 206 instructing the server 208 to do so. This may be possible if the server 208 has access to information regarding with which at least one further user account the created event is to be shared. The user account and the at least one further user account are associated with a specified subset of user accounts from at least one group of user accounts. Each one of the user account and the at least one further user account may generally correspond to a unique user. In other words, each user account may be associated with a unique user. However, one user may have more than one user account, and one user account may be associated with a group of users. The specified subset of user accounts may be defined by user accounts belonging to a common subset of user accounts in a social networking service. Thus, if the server 208 has access to this information, the server 208 can share the created event with the at least one further user account without receiving explicit instructions from the communications device 100, 202, 206 (by which the event has been created) to do so. According to an embodiment the created event is constrained to user accounts connected to a common social networking service. As a non-limiting example, in the social networking service called Facebook the created event may be constrained to members being denoted as “friends” to a user of the user account to which the created event is associated. For this non-limiting example the wording “specified subset of user accounts” thus corresponds to the group of “friends” of a specific user account on Facebook and the wording “at least one group of user accounts” thus corresponds to all user accounts on Facebook. The skilled person understands that there are other similar social networking services having similar hierarchies and associations between its members (as represented by user accounts).

As noted above, there are different ways of sharing the event. The created event may, for example, be shared by transmitting messages between physical entities associated with the user account and the at least one further user account. According to an example, a message pertaining to the created event is transmitted from the communications device 100, 202, 206 associated with the user account to at least one further communications device 100, 202, 206 associated with the at least one further user account. The actual physical process may involve communicating a plurality of messages between the communications devices 100, 202, 206, either directly or via the network 210, the centralized server 208 and/or the base stations 212, 214. Transmission of the message may, for example, be based on near field communications (NFC) between the communications device 100, 202, 206 associated with the user account and the at least one further communications device 100, 202, 206 associated with the least one further user account. The transmission of the message(s) may be triggered by user input. For example, a user of the user account may interact with the user interface 110 of the communications device 100, 202, 206, thereby instructing the communications device 100, 202, 206 to transmit the message. As an example the message may be transmitted according to a short message service (SMS) or a multimedia message service (MMS). The message may alternatively be transmitted as an electronic mail.

In a step S08, captured media items are connected to the created event. The connecting may be performed in the processing unit 104 or in the server 208. The captured media items are associated with the user account or the at least one further user account. In other words, before being connected to the created event the captured media items are accessible either by the user account or the at least one further user account. Thus, in general the captured media items are associated with user accounts and not necessarily with the actual device(s) on which the captured media items are stored.

As noted above, a context may be used to limit the created event in time and/or space. In terms of the captured media items, the media capturing unit 112, when capturing the media item, may provide the media item with auxiliary data, such as time and/or place of capture, for example by utilizing a built in, or external, clock and/or GPS unit. The media capturing unit 112 may thereby have access to information regarding when and where the media item was captured. The media capturing unit 112 may also, by using a NFC interface, gather information regarding other media capturing devices being within the NFC transmitting/receiving radius of the media capturing unit 112. For example, the media capturing unit 112 may be provided with (or be operatively coupled to) a Bluetooth radio interface, and by using the Bluetooth radio interface the media capturing unit 112 may be able to receive information relating to Bluetooth profiles of the other media capturing devices. For example, the communications unit 108 of the communications device 100, of which the media capturing unit 112 is part of or operatively coupled to, may be arranged to listen to Bluetooth profiles (as transmitted by Bluetooth enabled devices). Such information may be used as part of a object recognition system implemented in the processing unit 104 in order to determine identities of persons associated with the captured media items (inter alia, who captured the media item is and whose voice and/or image that is present in the media item). The person who captured the media item may also be determined by recognizing the photographer by (an additional) camera of the media capturing unit 112. Feature and object recognition processing mechanisms are as such known in the art.

For example, the captured media item may be a digital image which may depict a face of a human being. A data miner, as implemented by the processing unit 104, performing the below disclosed extraction and cross-correlation processing mechanisms may have access to face recognition processing mechanisms in order to determine the identity of the human being to be that of “Person 1”. Further, meta data of the digital image may include information, for example in form of a list, regarding NFC devices operatively connected to the image capturing unit 112 which captured the digital image in question. The list of NFC devices may be connected to an address book associated with the image capturing unit 112 via the communications device 100, 202, 206. For example the address book may be stored in a memory 106 accessible by the processing unit 104 of the communications device 100, 202, 206. The data miner may receive meta data from a plurality of devices and may by using such meta data it establishes associations between different users. The data miner may also have access to cell data (e.g. specifying the location for a certain mobile phone at a certain time) for mobile communications networks from components, such as access points, of the network 210 and from base stations 212, 214. The data miner may use this information to associate the NFC devices with user identities, for example “Person 2” and “Person 3”. Further information may include data specifying a particular event denoted “Event 1” taking place at the determined geographical location at the time specified in the image meta data. As a result thereof the data miner may draw the conclusion that “Person 1, Person 2 and Person 3 are present at Event 1” although “Person 2” and “Person 3” are not present in (or cannot be identified in) the captured digital image. In order to avoid performance bottlenecks, object recognition, such as face recognition, may according to embodiments only be performed amongst objects associated with NFC devices operationally connected to the image capturing unit 112 or the communications device 100, 202, 206 at the time of image capture.

By the user account application being connected to one or more social networking services the processing unit 104 and/or the server 208 is able to, for example by performing queries, aggregate content of the users' social networking service(s) into structured created events. The user account application may thereby be able to understand that the media items from the same GPS position and point in time from different user accounts but within the same social networking service likely are participating in the same event. The connections to the one or more social networking services may further allow faces to be connected to names, news to be connected to people, places to be connected to events, etc, for example by performing the below disclosed extraction and cross-correlation processing mechanisms. The created events and the information about them thus allow capturing of further media items around them, as well as recording the access patterns to understand the relations and relevance of each created event.

There are different ways of representing the created event and connecting captured media items to the created event. For example, the created event may be represented by meta data. Captured media items may thereby be connected to the created event by associating the captured media items with the meta data. The application as run by the communications device 100, 202, 206 or the server 208 may thereby automatically add informative text to the event regarding the event when event is or has been created. This may be accomplished, for example by adding meta data to the event when the event is or has been created, where the meta data relates to a further context. The further context may be a more detailed than the original context of the created event. According to one embodiment the captured media items may have been associated with tags prior to the event being created. The event may then be created subsequently based on the tags.

Captured media items connected to the created event may together with the meta data and/or tags be uploaded to a computer environment, such as a computer based cloud service which in FIG. 2 is schematically represented by the network 210. The created event, including its media items, is to the computer environment uploaded up to a certain resolution. The resolution is preferably based on network conditions, and/or power level (such as battery life) of the communications device(s) 100, 202, 204, 206 and/or server 208 storing the captured media items. The final full size data of media items associated with the created event is advantageously not uploaded until the communications device(s) 100, 202, 204, 206 and/or server 208 storing the captured media items has a wired or wireless broadband network connection. In this computer environment processing mechanisms can be instantly started. The processing mechanisms (which for example may be performed by the communications device 100, 202, 206 or the server 208) may, for example involve extracting and cross-correlating the content and the context of the of the created event by extracting and cross-correlating the meta data, tags, captured media items, and/or created event with previously generated/created meta data, tags, captured media items, and/or created events. The created events may thereby be enhanced with intelligence and put into their social context (for example by considering the one or more social networking service(s) associated with the created event during the processing. A collection of related created events may thereby be generated.

Each created event may have a unique identity code. The identity code may be represented by a sequence of alphanumerical characters. There are different ways of associating the event with the unique identity code. For example, the unique identity code may be incorporated in, or be an integral part of, the tag and/or meta data. Thus the created event may be provided with the identity code when meta data is associated with the created event. Alternatively the unique identity code may be stored separately from the connected captured media items at least during duration of the created event. The created event may be limited to a duration in time. That is, only media items which are captured within a specified duration in time may be added to or associated with the created event. The created event may have a start time and a stop time, which for example may be specified by a user of the user account by which the event is created. However, although the created even has a predetermined duration in time (for example defined by a predetermined start time and a predetermined stop time), captured media items may still be added to or associated with the event outside the predetermined duration in time of the event, as long as the captured media items to be added have been captured within the predetermined duration in time. Similarly, the created event may be limited to a geographical location.

In a step S10, (both) the user account and the at least one further user account are provided access to the connected media items. The accessing may be performed in the processing unit 104 or in the server 208. The connected media items are thereby enabled to be shared amongst the user account and the at least one further user account. Hence, captured media which was previously only accessible by one of the the user account and the at least one further user account is, when connected to the created event, made accessible to both the user account and the at least one further user account, thus enabling sharing thereof.

It may be possible to add received captured media items to an already created event. The received captured media items may either have been received before the event has been created or after the event has been created. The received captured media items may then be connected to the created event. The connecting of such received captured media items may be administrated either by the user account and/or the at least one further user account having access to the created event. However, the connecting of such received captured media items may be restricted such that only the user account having the role of moderator (see below) receives and/or is enabled to connect the captured media items to the created event.

A plurality of events may be created according to the above disclosed steps and acts. Thus, different users may, via respective user accounts, create different events. As also disclosed above, events may be automatically created. This may lead to a situation where there may be a plurality of created events that have at least partly overlapping scope. The overlapping scope may relate to created events having overlapping time duration, geographical location and/or name. As explained in further detail below, it may be advantageous to associate such plurality of created events with each other, for example by merging two or more events.

Where a plurality of created events have been created (and wherein the plurality of events are accessible by the user account) the plurality of created events may be rated according to predetermined criteria. According to an embodiment the rating (and hence the predetermined criteria) depends on how many user accounts that are associated with each one of the plurality of created events. A created event associated with many user accounts may have a higher rating than a created event associated with fewer user accounts (in relation to the created event associated with many user accounts). Other criteria may pertain to the name of the event; a created event which, according to a dictionary, has a correct spelling, may be higher ranked than a created event having a name that is incorrectly spelled. The ranking may be performed by the processing unit 104 which thus may have access to dictionary information. The dictionary information may be stored in the memory 106, or may be provided by the network 210. Alternatively the ranking is performed by the server 208. Manually created events may be ranked higher than automatically ranked events. Information related to at least a sub-set of the rated plurality of events may be sent to a user interface associated with the user account. The user account is then enabled to participate in at least one of the sub-set of the rated plurality of events. The predetermined criteria may also relate to the number of aggregated so-called “check-ins”, or similar services, from social networking services such as FourSquare, Gowalla, and/or Facebook, and may present them as possible events if they are highly likely.

According to embodiments it may thereby not be important which user account that initiated the creation of the event. It may be more important to track different created events such that two or more created events relating to the same context may be registered as one and the same created event. Preferably such tracking is performed by the server 208. This makes the ownership of the created event communal, giving conversation and comments which may be attached to the created event a truly social context. Conversation and comments may be provided through the user interface 110 and then attached to the created event by the processing unit 104. However, according to embodiments the user account initiating the creation of the event can make the event private or exclude user accounts from the event. For a private event the user account initiating the creation of the event may thus be authorized to explicitly determine with which at least one further user account that the created event is to be shared with. One of the user account and the at least one further user account may thus act as a moderator of the created event. Upon reception of user input (received by the user account acting as the moderator) identifying at least one user account from the at least one further user account to be excluded from the created event this user account may be excluded from the created event by the user account acting as the moderator.

The user account having the role of moderator may further have authorization to approve captured media items before the captured media items are added to the created event. Upon addition of a new captured media item to a created event, the user account having the role of moderator may receive information that the new captured media item is to be added to the created event. The user account having the role of moderator may thereafter decide whether or not the new captured media item is to be added to the created event. In order to do so a thumbnail version of the new captured media item to be added may be presented to a user interface of a device associated with the user account having the role of moderator so that a user of the user account having the role of moderator is able to approve or decline acceptance of adding the new captured media to the created event. Alternatively, the decision regarding acceptance of adding the new captured media to the created event may be taken without user interaction, for example by analyzing the content and/or context of the new captured media item, for example by passing the new captured media item through one or more filters. Captured media items which by user accounts not having the role of moderator are to be added to the created event may thereby be either added to or discarded from the created event.

In case the user (by means of the user account—for example by providing user input via user interface 110 to the user account) declines to participate in at least one of the plurality of events having been actively created the user account may be associated with another one of the plurality of events. Particularly the user account may be associated with such an event that has been automatically created based on identification data from at least one WLAN, GPS coordinates, and/or Bluetooth identification data.

Wherein a plurality of events have been created, and where the plurality of events are accessible by the (same) user account, at least two of the plurality of events may be merged, thereby creating a single event. For example, several events relating to the same subject may have been created independently by different user accounts. It could also be the case that one event has been automatically created. One way to determine whether or not events are related is to compare the names of the created events together with time and/or place associated with the events. For example, if events are independently created by different user accounts within a predetermined time frame, say within one hour, and/or within a predetermined distance, say 1000 meters, from each other, it could be the case that these events relate to one and the same subject. Particularly so if the names of the events are related according to some criteria. The names may for example be related by having a similar (or even the same) spelling, one name being an abbreviation of the other(s), the names having the same meaning but are being expressed in different languages, or a combination of these criteria. It may thus be advantageous to merge such events into one single event. There may be different alternatives regarding how to handle such situations. According to a first example at least two of the plurality of events are retained as separate events in addition to the created single event. According to a second example at least one of the at least two of the plurality of events is deleted subsequently to merging the at least two of the plurality of events. For example, if a first event has already been created by a first user account and it is determined, for example by the data miner functionality, that a potentially related second event is in the process of being created by initiation of a second user account, a message may be sent, for example from the server 208 to the communications device 100, 202, 206 on which the second user account initiating the creation of the second event that the second event may be related to the first event. The user of the communications device 100, 202, 206 on which the second user account is initiating the creation of the second event may thus be informed (via the user interface 110 of the communications device 100, 202, 206) of the existence of the first event so that the first user account may join the first event instead of continuing the process of creating a separate second event. This procedure may be limited to the case wherein the first user account and the second user account are associated with a specified subset of user accounts from at least one group of user accounts. The procedure may also apply to the case wherein the first event has been automatically created—the first event is in this case as such not associated with a specific user account upon its creation.

It may also be beneficial to split the created event into two or more sub-events. The created event may thus comprise at least one sub-event. There may be different ways of deciding when it is appropriate, beneficial, or even necessary to split a created event into two or more sub-events. According to an embodiment the number of captured media items associated with the created event are counted and the event is split into at least two sub-events in case the number of media items associated with the event exceeds a predetermined number. Thus according to this embodiment the created event is split if the number of elements are greater than a threshold value.

There may be other criteria for splitting the created event into two or more sub-events. For example, one or more sub-events may be directly or indirectly created within the created event. The sub-event may be defined as occurring within a sub-interval of the time interval of the event. As an alternative or in addition thereto, the sub-event may be defined as occurring in a sub-location of the geographic location of the event. As a further alternative or in further addition thereto, the at least one sub-event may be defined as being associated with a context being a further specification of the user input (in case the event was created and named by means of user input). For example, according to an illustrative example, consider a trip involving a user of a user account travelling to a number of destinations. At each destination one or more media items are captured. One event (hereinafter denoted the “base event”) may be created to represent media items captured during the trip. The entire trip can thus be represented by one such base event. Each day of the trip may consist of multiple sub-events of the base event and may be categorized and/or defined by time, space and/or explicit user input. Some or all of the sub-events may comprise sub-sub-events. The base event, the sub-events and the sub-sub-events may thus be hierarchically organized. According to embodiments the splitting of an event into sub-events may occur after each event has been created as a separate event. Thus each event may be created as an independent base event and later be organized into one base event and one or more sub-events.

FIG. 3 at reference numeral 300 schematically illustrates a number of created events denoted “Event A”, “Event A.b”, “Event A.a”, “Event A.b.a”, “Event B” and “Event C” and their associations to user accounts denoted “User 1”, “User 2” and “User 3”. A more detailed description of the created events “Event A”, “Event A.b”, “Event A.a”, “Event A.b.a”, “Event B” and “Event C” is provided with reference to FIGS. 4a-f. Created events “Event A”, “Event B” and “Event C” are base events. Base event “Event A” comprises sub-events “Event A.a” and “Event A.b” respectively. Sub-event “Event A.b” furthermore comprises sub-event “Event A.b.a”, Thus event “Event A.b.a” is a sub-sub-event of event “Event A”, Created events “Event A”, “Event A.a”, “Event A.b” and “Event A.b.a” are associated with user accounts “User 1” and “User 2”. Created event “Event A.b.a” is also associated with user account “User 3”. Created event “Event B” is associated with user account “User 1”. Created event “Event C” is associated with user accounts “User 2” and “User 3”.

User accounts “User 1” and “User 2” have the status “friends” in the social networking service “X”. User accounts “User 1”, “User 2” and “User 3” have the status “colleagues” in the social networking service “Y”. User accounts “User 2” and “User 3” also have the statuses “friends” in the social networking service “Y”, see also FIG. 6. As noted above, the exemplary statuses “friends” and “colleagues” are mere examples of a plurality of possible statuses.

FIGS. 4a-f are schematic illustrations 410, 420, 430, 440, 450, 460 of the created events “Event A”, “Event A.b”, “Event A.a”, “Event A.b.a”, “Event B” and “Event C”. As seen in FIG. 4a the created event “Event A” is a base event and has an event identity HUB767 and a name “Florida Trip”. It was created manually by user account “User 1”. “Event A” has a duration in time between 1 Mar. 2011 and 6 Mar. 2011. “Event A” is not restricted to a particular geographical location. Media items associated with “Event A” are shared between all user accounts associated with members with status “friends” in relation to user account “User 1” in the social networking service “X”; thus between user accounts “User 1” and “User 2”.

As seen in FIG. 4b the created event “Event A.b.a” is a sub-event of the event with identity ABC123 and has an event identity APF993 and a name “Florida Trip >> Key West >> Jim's b′day party”. It was originally created manually by user account “User 2”. Thus, for user accounts “User 1” and “User 2” “Event A.b.a” is a sub-event of “Event A.b” named “Key West” and a sub-sub-event of “Event A” named “Florida Trip”. However, for user account “User 3”, which is neither associated with “Event A” nor “Event A.b”, “Event A.b.a” may be regarded as a base moment and for “User 3”, “Event A.b.a” may have the separate name “Jim's b′day party”. Similarly, for “User 3”, “Event A.b.a” may be a sub-event of another event (not shown in FIG. 3). “Event A.b.a” is not restricted to a particular point in time. “Event A.b.a” is constrained in geographical location to the coordinates 24°33′N, 81°47′W. Media items associated with “Event A.b.a” are shared between all user accounts associated with all members with status “colleague” in relation to user account “User 2” in the social networking service “Y”; thus between user accounts “User 1”, “User 2” and “User 3”.

As seen in FIG. 4c the created event “Event A.a” is a sub-event of the event with identity HUB767 and has an event identity DEF456 and a name “Florida Trip >> Tuesday”. It was created manually by user account “User 1”, “Event A.a” has a duration in time between 0:00 AM and 11:59 PM on the Tuesday occurring in the interval of “Event A”, thus on Tuesday 1 Mar. 2011. Sub-event “Event A.a” is not restricted to a particular geographical location. Media items associated with “Event A.a” are shared between all user accounts associated with members with status “friends” in relation to user account “User 1” in the social networking service “X”; thus between user accounts “User 1” and “User 2”.

As seen in FIG. 4d the created event “Event A.b” is a sub-event of the event with identity HUB767 and has an event identity ABC123 and a name “Florida Trip >> Key West”. It was manually by user account “User 1”. “Event A.b” is not restricted to a particular point in time. Sub-event “Event A b” is constrained to user accounts associated with communications devices within the transmission radius of the WLAN access point “Z” located at the coordinates 24°33′33″N, 81°47′2.51″W. Media items associated with “Event A.b” are thus shared between such user accounts; in the instant example between user accounts “User 1” and “User 2” (assuming that corresponding communications devices are within the transmission radius of said access point “Z”). The communications devices 100, 202, 206 do not need to be operatively connected to the WLAN access point “Z” in order to be associated with said access point “Z”. Instead the particular access point may be regarded as a geographical tag and may thus be used in the same way as GPS coordinates, where the event is tagged with the identity of said particular access point instead of the specific GPS coordinates at which said particular access point is located. For example, the user account application run on the communications device 100, 202, 206 may receive information, via the processing unit 104 and/or operating system 102, from the communications unit 108 that the communications device 100, 202, 206 is within the transmission radius of a particular WLAN access point. This information may be presented to a user via the user interface 110 of the communications device 100, 202, 206. The user may thereby be able to provide user input that media items captured while the communications device 100, 202, 206 is within the transmission radius of said particular WLAN access point are to be tagged with the identity of said particular WLAN access point. Alternatively, such information may be incorporated automatically in auxiliary data, such as Exif data, of the media item upon its capture. Yet alternatively the user may prompt the user account application run on the communications device 100, 202, 206 to via the communications unit 108 search for such WLAN access points in order to receive information relating to already created events associated with such WLAN access points.

As seen in FIG. 4e the created event “Event B” is a base event and has an event identity GHJ789 and a name “Conference in Lund”. It was created manually by user account “User 1”. “Event B” has a duration in time between 2 May and 3 May 2011. “Event B” is constrained in geographical location to communications devices operatively coupled to access point W. Media items associated with “Event B” are shared between all user accounts associated with members with status “colleague” in relation to “User 1” in social networking service “X”; thus of the user accounts shown in FIG. 3 only by user account “User 1”.

As seen in FIG. 4f the created event “Event C” is a base event and has an event identity KVD112 and a name “Pictures of Frank”. It was created manually by user account “User 3”. “Event C” is neither restricted to a particular point in time; nor to a particular geographical location. Media items associated with “Event C” are shared between all user accounts associated with members with status “friends” in relation to “User 3” in social networking service “Y”; thus between user account “User 2” and “User 3”.

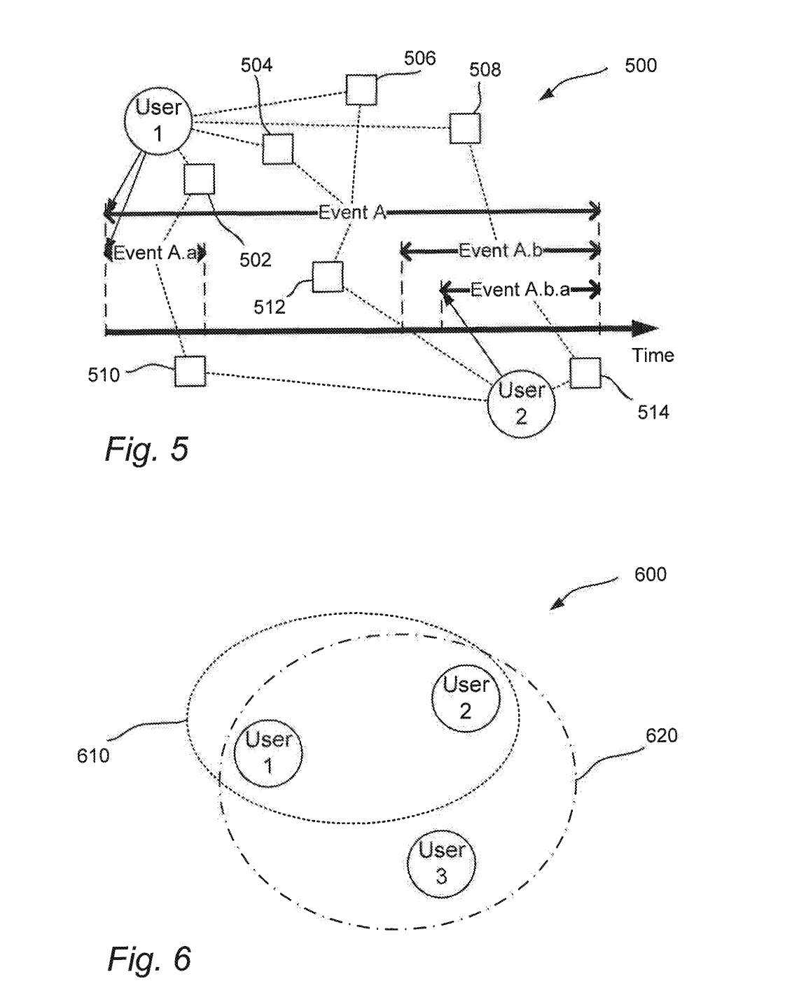

FIG. 5 schematically illustrates at reference numeral 500 a number of created events along a time line and thus illustrates how the created events are related in time. The created events are the same as in FIG. 3 and FIGS. 4a-d, i.e., created events denoted “Event A”, “Event A.a”, “Event A.b”, and “Event A.b.a”. Thus, “Event A”, “Event A.a” and “Event A.b” have been manually created by user account “User 1”; and “Event A.b.a” has been manually created by user account “User 2”. FIG. 5 also illustrates a number of captured media items 502, 504, 506, 508, 510, 512 and 514 along with the user accounts associated with their capture. Captured media items 502, 504, 506, 508 have been captured by user account “User 1” whilst captured media items 510, 512, 514 have been captured by user account “User 2”. Captured media items 502 and 510 are associated with “Event A.a”; captured media items 504, 506 and 512 are associated with “Event A”; captured media item 508 is associated with “Event kb”; and captured media item 514 is associated with “Event A.b.a”. Thus, according to the above disclosed mechanisms for sharing media items, captured media items 502, 504, 506, 508, 510, 512 and 514 are shared between user accounts “User 1” and “User 2”.

FIG. 6 at reference numeral 600 schematically illustrates how user accounts may be related in different groups. A first sub-group is denoted 610 and includes user accounts “User 1” and “User 2” whilst a second sub-group denoted 620 includes user accounts “User 1”, “User 2” and “User 3”. With reference to FIG. 3 and FIGS. 4a-f the first sub-group 610 may thus correspond to ‘user accounts associated with all members with status “friends” in relation to user account “User 1” in the social networking service “X”. With reference to FIG. 3 and FIGS. 4a-f the second sub-group 620 may thus correspond to user accounts associated with all members with status “colleague” in relation to user account “User 2” in the social networking service “Y”.

The invention has mainly been described above with reference to a certain examples. However, as is readily appreciated by a person skilled in the art, other examples than the ones disclosed above are equally possible within the scope of the invention, as defined by the appended patent claims.

1-39. (canceled)

40. A method comprising facilitating a processing of and/or processing (1) data and/or (2) information and/or (3) at least one signal, the (1) data and/or (2) information and/or (3) at least one signal based, at least in part, on the following:
creating an event for media items, the event being associated with a context;
associating the created event with a user account;
sharing the created event with at least one further user account, the user account and the at least one further user account being associated with a specified subset of user accounts from at least one group of user accounts;
connecting captured media items to the created event, the captured media items being associated with the user account or the at least one further user account; and
providing the user account and the at least one further user account access to the connected media items, thereby enabling the connected media items to be shared amongst the user account and the at least one further user account.

41. The method according to claim 40, wherein the created event is associated with captured media items from both the user account and the at least one further user account.

42. The method according to claim 40, wherein the created event is represented by meta data, and wherein the captured media items are connected to the created event by associating the captured media items with the meta data.

43. The method according to claim 40, wherein the specified subset of user accounts is defined by user accounts belonging to a common subset of user accounts in a social networking service.

44. The method according to claim 40, wherein the created event is constrained to user accounts connected to a common social networking service.

45. The method according to claim 40, wherein the context pertains to at least one from a limited time interval, and a geographical location.

46. The method according to claim 40, wherein the context is specified by user input.

47. The method according to claim 40, wherein the created event is automatically created based on identification data from at least one WLAN, GPS coordinates, and/or Bluetooth identification data.

48. The method according to claim 40, wherein a plurality of events have been created, the plurality of events being accessible by the user account, the method further comprising
rating the plurality of events according to predetermined criteria;
transmitting information related to at least a sub-set of the rated plurality of events to a user interface associated with the user account; and
enabling the user account to participate in at least one of the sub-set of the rated plurality of events.

49. The method according to claim 40, wherein a plurality of events have been created, the plurality of events being accessible by the user account, the method further comprising
merging at least two of the plurality of events, thereby creating a single event.

50. The method according to claim 40, further comprising
counting the number of captured media items associated with the created event; and
splitting the created event into at least two sub-events in case the number of captured media items associated with the created event exceeds a predetermined number.

51. The method according to claim 40, wherein the captured media items have been associated with tags prior to the event being created, and wherein the event is created subsequently based on the tags.

52. The method according to claim 40, wherein the created event is shared by
transmitting a message pertaining to the created event from a mobile communications device associated with the user account to at least one further mobile communications device associated with the at least one further user account.

53. The method according to claim 40, further comprising receiving captured media items, the media items having been received prior to or subsequent to creating the event; and
connecting the received captured media items to the created event.

54. The method according to claim 40, wherein one of the user account and the at least one further user account acts as a moderator of the created event, the method further comprising
receiving user input from the moderator, the user input identifying at least one user account from the at least one further user account to be excluded from the created event; and
excluding the at least one user account from the at least one further user account from the created event.

55. An apparatus comprising:
at least one processor; and
at least one memory including computer program code for one or more programs,
the at least one memory and the computer program code configured to, with the at least one processor, cause the apparatus to perform at least the following,
create an event for media items, the event being associated with a context;
associate the created event with a user account;
share the created event with at least one further user account, the user account and the at least one further user account being associated with a specified subset of user accounts from at least one group of user accounts;
connect captured media items to the created event, the captured media items being associated with the user account or the at least one further user account; and
provide the user account and the at least one further user account access to the connected media items, thereby enabling the connected media items to be shared amongst the user account and the at least one further user account.

56. The apparatus of claim 55, wherein the created event is represented by meta data, and wherein the captured media items are connected to the created event by associating the captured media items with the meta data.
